(19) United States
(12) Patent Application Publication
(10) Pub. No.: US 2015/0331564 A1
(43) Pub. Date: Nov. 19, 2015

(54) INTERACTION METHOD AND APPARATUS OF SMART DEVICE

(71) Applicant: TENCENT TECHNOLOGY (SHENZHEN) COMPANY LIMITED, Shenzhen (CN)

(72) Inventor: Yabei GUAN, Shenzhen (CN)

(21) Appl. No.: 14/810,189

(22) Filed: Jul. 27, 2015

Related U.S. Application Data
(63) Continuation of application No. PCT/CN2014/070771, filed on Jan. 17, 2014.

(30) Foreign Application Priority Data
Jan. 28, 2013 (CN) 201310031867.9

(51) Int. Cl. G06F 3/0482; G06F 3/0486; G06F 3/0488; G06F 3/0484

(52) U.S. Cl. CPC G06F 3/0482; G06F 3/04842; G06F 3/0486; G06F 3/0488

(57) ABSTRACT

According to an example, an interaction zone and at least one data interaction interface trigger zone are configured on a screen, and each of the at least one the data interaction interface trigger zone corresponds to a data interaction interface. A touch operation instruction is received, and a data interaction interface trigger zone is selected and moved on the screen according to the touch operation instruction. Whether the selected data interaction interface trigger zone is moved to the interaction zone is determined. If the selected data interaction interface trigger zone is moved to the interaction zone, a data interaction interface trigger instruction is generated, a data interaction interface corresponding to the selected data interaction interface trigger zone is displayed on the screen according to the data interaction interface trigger instruction, and data interaction is performed on the data interaction interface.

### CROSS REFERENCE TO RELATED APPLICATIONS

This application is a continuation of Application No. PCT/CN2014/070771, filed on Jan. 17, 2014. This application claims the benefit and priority to of Chinese Patent Application No. 201310031867.9, entitled “interaction method and apparatus of smart device” and filed on Jan. 28, 2013. The entire disclosures of each of the above applications are incorporated herein by reference in their entirety for all purposes.

### TECHNICAL FIELD

The present disclosure relates to information processing technologies, more particularly to, an interaction method and apparatus of a smart device.

### BACKGROUND

Along with the rapid development of computer technologies and network technologies, Internet technologies and the Instant Messenger (IM) technologies play an increasingly important role in people's daily life. Further, along with the development of mobile Internet, various information devices are emerged.

A smart device is a general term of terminals which has an independent operating system, and may access to a wireless network via a mobile communication network. In addition, functions of the smart device may be extended by installing applications provided by third-party service providers.

In various conventional interaction methods of the smart device, a user needs to select and confirm an interaction mode. The interaction mode includes an account balances mode, a bank card and etc. Currently, in the conventional interaction method, a list or a pop-up box is displayed in an interface of the interaction modes, and a user needs to select one interaction mode by performing a clicking operation. As can be seen, in the conventional interaction method, the user needs to click or pull-down a list box and select the interaction mode.

The conventional interaction method of the smart device is simply developed from web page interaction method, and the web page interaction method is based on mouse clicking operations. Since touch technologies are used by most of the smart devices, and the mouse clicking operations is not applicable to the smart devices, which makes the interaction procedure compliable and is not conducive to the efficiency of the interaction.

### SUMMARY

Examples of the present disclosure provide an interaction method and apparatus of a smart device, so as to reduce complexity of interaction procedure and improve efficiency of interaction.

An interaction method of a smart device includes:

configuring an interaction zone and at least one data interaction interface trigger zone on a screen; each of the at least one the data interaction interface trigger zone corresponding to a data interaction interface;

receiving a touch operation instruction; selecting and moving a data interaction interface trigger zone on the screen according to the touch operation instruction;

determining whether the selected data interaction interface trigger zone is moved to the interaction zone;

if the selected data interaction interface trigger zone is moved to the interaction zone, generating a data interaction interface trigger instruction; displaying a data interaction interface corresponding to the selected data interaction interface trigger zone on the screen according to the data interaction interface trigger instruction; and performing data interaction on the data interaction interface.

An interaction apparatus of a smart device includes:

a configuring unit, to configure an interaction zone and at least one data interaction interface trigger zone on a screen; each of the at least one the data interaction interface trigger zone corresponding to a data interaction interface;

a moving unit, to receive a touch operation instruction; select and move a data interaction interface trigger zone on the screen according to the touch operation instruction; and

a displaying unit, to determine whether the selected data interaction interface trigger zone is moved to the interaction zone; if the selected data interaction interface trigger zone is moved to the interaction zone, generate a data interaction interface trigger instruction; display a data interaction interface corresponding to the selected data interaction interface trigger zone on the screen according to the data interaction interface trigger instruction; and perform data interaction on the data interaction interface.

Therefore, according to the examples of the present disclosure, the interaction zone and at least one data interaction interface trigger zone are configured on the screen, and each of the at least one the data interaction interface trigger zone corresponding to one data interaction interface. The touch operation instruction is received, and the data interaction interface trigger zone is selected and moved on the screen according to the touch operation instruction. It is determined whether the selected data interaction interface trigger zone is moved to the interaction zone. If the selected data interaction interface trigger zone is moved to the interaction zone, the data interaction interface corresponding to the selected data interaction interface trigger zone is displayed on the screen and data interaction is performed on the data interaction interface. By using the examples of the present disclosure, many click operations are eliminated, the selecting and interaction determining of the data interaction interface trigger zone is implemented by using the dragging operation, thereby reducing complexity of the user operations and to improving interaction efficiency.

### BRIEF DESCRIPTION OF THE DRAWINGS

FIG. 1 is a schematic diagram illustrating a conventional data interaction interface of a smart device.

FIG. 2 is a schematic diagram illustrating another conventional data interaction interface of a smart device.

FIG. 3 is a schematic flowchart illustrating an interaction method of a smart device according to various examples of the present disclosure.

FIG. 4 is a schematic diagram illustrating an interaction interface of a smart device according to various examples of the present disclosure.

FIG. 5 is a schematic diagram illustrating another interaction interface of a smart device according to various examples of the present disclosure.

FIG. 6 is a schematic diagram illustrating another interaction interface of a smart device according to various examples of the present disclosure.

FIG. 7 is a schematic diagram illustrating logic layers for implementing interaction of a smart device according to various examples of the present disclosure.

FIG. 8 is a schematic diagram illustrating an interaction apparatus of a smart device according to various examples of the present disclosure.

### DETAILED DESCRIPTION

The examples of the present application provide the following technical solutions.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The servers and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

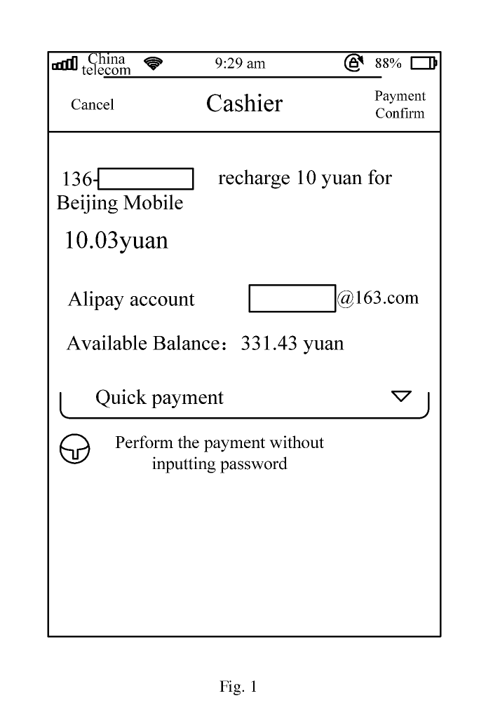

The description will be made as to the various embodiments in conjunction with the accompanying drawings in FIGS. 1-8. It should be understood that specific embodiments described herein are merely intended to explain the present disclosure, but not intended to limit the present disclosure. In accordance with the purposes of this disclosure, as embodied and broadly described herein, this disclosure, in one aspect, relates to interaction method and apparatus of a smart device.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

In various conventional online interaction methods of the smart device, a user needs to select and confirm an interaction mode by using a clicking mode. The interaction mode includes an account balances mode, a bank card and etc. An interface displayed during the interaction mainly includes a list or a pop-up box, and a user needs to select one interaction mode by performing a clicking operation on the list or the pop-up box.

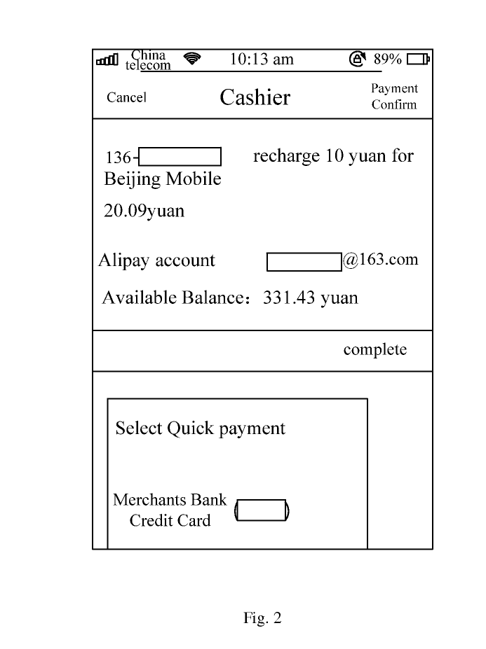

FIG. 1 is a schematic diagram illustrating a conventional data interaction interface of a smart device, and FIG. 2 is a schematic diagram illustrating another conventional data interaction interface of a smart device.

As shown in FIG. 1 and FIG. 2, the user needs to perform multiple clicking operations to implement one interaction procedure, and thus the interaction procedure is compliable and is not conducive to the efficiency of the interaction.

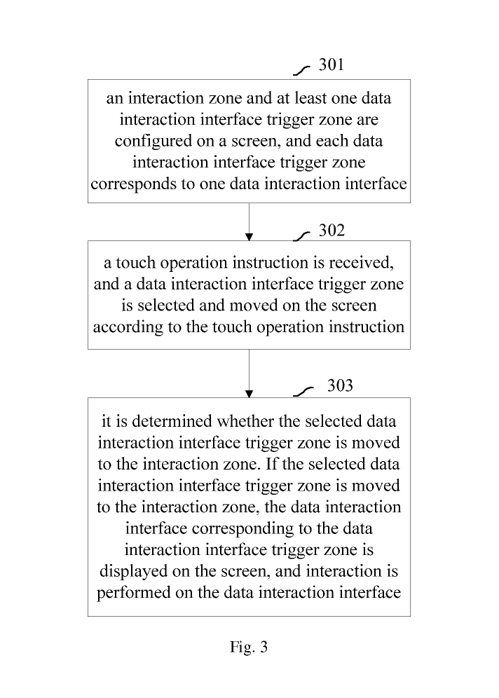

FIG. 3 is a schematic flowchart illustrating an interaction method of a smart device according to various examples of the present disclosure. As shown in FIG. 3, the method includes the following processing.

At 301, an interaction zone and at least one data interaction interface trigger zone are configured on a screen, and each data interaction interface trigger zone corresponds to one data interaction interface.

According to an example, the interaction zone and the at least one data interaction interface trigger zone may be configured on a screen of a smart device, and each of the at least one data interaction interface trigger zone corresponds to a data interaction interface. The data interaction interface trigger zone may include at least one of an account balance data interaction interface trigger zone, a bank card data interaction interface trigger zone, a mobile bank data interaction interface trigger zone and a shortcut data interaction interface trigger zone. Each type of the data interaction interface trigger zone has a corresponding data interaction interface. For example, the account balance data interaction interface trigger zone corresponds to an account balance data interaction interface, the bank card data interaction interface trigger zone corresponds to a band card data interaction interface, the mobile bank data interaction interface trigger zone corresponds to a mobile bank data interaction interface, and the shortcut data interaction interface trigger zone corresponds to a shortcut data interaction interface. The shortcut data interaction interface trigger zone may be a quick payment box.

According to examples of the present disclosure, there may be various interaction modes, and thus multiple data interaction interface trigger zones may be configured on the screen of the smart device. According to an example, a data interaction interface trigger zone list may be configured on the screen, and the data interaction interface trigger zone list includes at least two data interaction interface trigger zones.

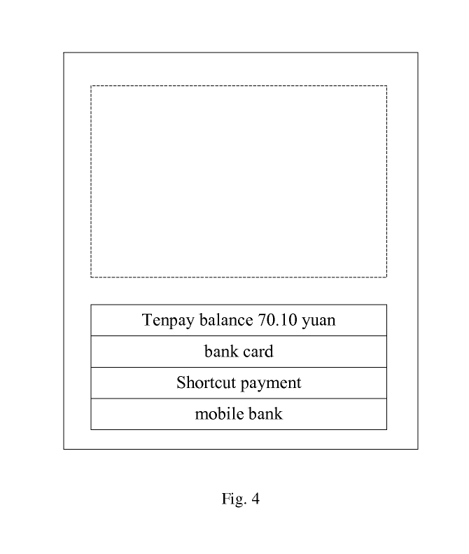

FIG. 4 is a schematic diagram illustrating an interaction interface of a smart device according to various examples of the present disclosure. As shown in FIG. 4, a dashed rectangle at the top of the screen is the configured interaction zone, and 4 data interaction interface trigger zone are configured below the interaction zone, which are an account balance data interaction interface trigger zone, a bank card data interaction interface trigger zone, a mobile bank data interaction interface trigger zone and a shortcut data interaction interface trigger zone respectively.

According to examples of the present disclosure, the smart device includes but not limited to: a functional phone, a smart phone, a PC, a tablet PC, or a PDA. According to examples of the present disclosure, the smart device is applicable to any smart device operating system includes but not limited to: Android, Palm OS, Symbian, Windows mobile, Linux, iPhone, OS, Black Berry OS 6.0, or Windows Phone series.

According to examples of the present disclosure, the Android operating system may be used by the smart device, and the versions of the Android operating system includes but not limited to: Android Beta, Android 1.0, Android 1.5, Android 1.6, Android 2.0/2.1, Android 2.2, Android 2.3, Android 3.0, Android 4.0, Jelly Bean, Android 4.1.

At 302, a touch operation instruction is received, and a data interaction interface trigger zone is selected and moved on the screen according to the touch operation instruction.

The examples may be applied to smart devices having a touch screen. The type of the touch screen of the smart device may be single-touch, multi-touch with recognizing a direction of a finger, multi-touch with recognizing a position of a finger, etc.

According to an example, the touch screen may be a resistive technology touch screen, a capacitive technology touch screen, an infrared technology touch screen, a surface acoustic wave technology touch screen, and etc.

According to an example, the touch screen of the smart device receives the touch operation instruction sent by a user, and the data interaction interface trigger zone is selected and moved on the screen according to the touch operation instruction.

According to an example, when the data interaction interface trigger zone list includes multiple data interaction interface trigger zones, after the touch operation instruction sent by the user is received, the data interaction interface trigger zone may be selected from the data interaction interface trigger zone list according to the touch operation instruction, and the selected data interaction interface trigger zone is moved according to the touch operation instruction.

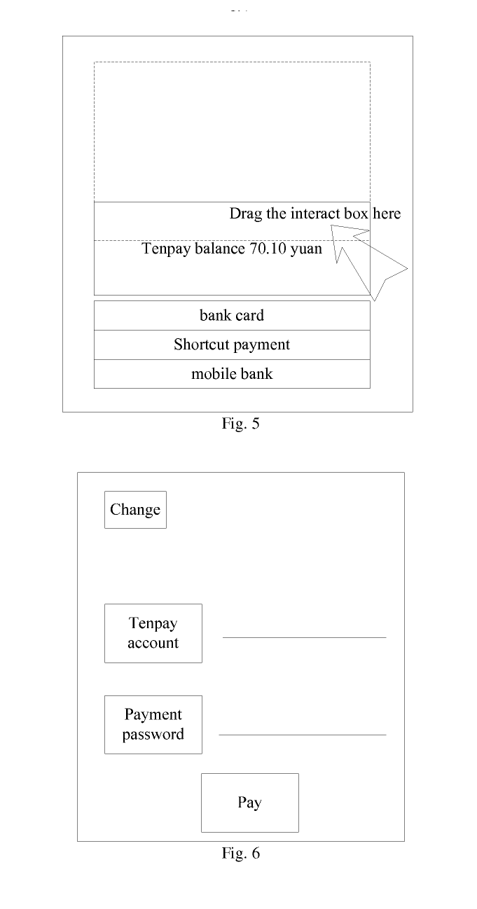

FIG. 5 is a schematic diagram illustrating another interaction interface of a smart device according to various examples of the present disclosure. As shown in FIG. 5, a TenPay balance data interaction interface trigger zone is dragged to the interaction zone by the user.

At 303, it is determined whether the selected data interaction interface trigger zone is moved to the interaction zone. If the selected data interaction interface trigger zone is moved to the interaction zone, the data interaction interface corresponding to the data interaction interface trigger zone is displayed on the screen, and interaction is performed on the data interaction interface.

According to an example, it is determined whether the entire selected data interaction interface trigger zone is moved to the interaction zone. If the entire selected data interaction interface trigger zone is moved to the interaction zone, the data interaction interface trigger instruction is generated, and the data interaction interface corresponding to the data interaction interface trigger zone is displayed on the screen according to the data interaction interface trigger instruction, and interaction is performed on the data interaction interface.

According to an example, it is determined whether the partial selected data interaction interface trigger zone is moved to the interaction zone. If the partial selected data interaction interface trigger zone is moved to the interaction zone, the data interaction interface trigger instruction is generated, and the data interaction interface corresponding to the data interaction interface trigger zone is displayed on the screen according to the data interaction interface trigger instruction, and interaction is performed on the data interaction interface.

For example, when it is determined that one third of the selected data interaction interface trigger zone is moved to the interaction zone, the data interaction interface trigger instruction is generated, and the data interaction interface corresponding to the data interaction interface trigger zone is displayed on the screen according to the data interaction interface trigger instruction, and interaction is performed on the data interaction interface. For another example, when it is determined that half of the selected data interaction interface trigger zone is moved to the interaction zone, the data interaction interface trigger instruction is generated, and the data interaction interface corresponding to the data interaction interface trigger zone is displayed on the screen according to the data interaction interface trigger instruction, and interaction is performed on the data interaction interface. According to examples of the present disclosure, other proportions for triggering the generation of the data interaction interface trigger instruction may be used.

According to an example, the operating system of the smart device is iOS, A user interface gesture recognizer (UIGestureRecognizer) class may be configured for the data interaction interface trigger zone. The position information of the selected data interaction interface trigger zone on the screen is obtained by using the UIGestureRecognizer class, and it is determine whether the selected data interaction interface trigger zone is moved to the interaction zone according to the position information. If the selected data interaction interface trigger zone is moved to the interaction zone, the data interaction interface corresponding to the data interaction interface trigger zone is displayed on the screen, and interaction is performed on the data interaction interface.

The UIGestureRecognizer is an abstract class, defines basic actions of all gesture, and has 6 sub-classes for processing specific gestures. The 6 sub-classes include 1. UITapGestureRecognizer, which corresponds to a clicking operation performed by any finger for any times; 2. UlPinchGestureRecognizer, which corresponds to a pinch operation performed by two fingers; 3. UIPanGestureRecognizer, which corresponds to a shaking or dragging operation; 4. UISwipeGestureRecognizer, which corresponds to a swiping operation performed by a finger on a screen; 5. UIRotationGestureRecognizer, which corresponds to a rotation operation performed by a finger on a screen; 6. UILongPressGestureRecognizer, which corresponds to a long press operation.

According to an example, in the method, after determining that the selected data interaction interface trigger zone is moved to the interaction zone, it is further determined whether the data interaction interface is moved out of the interaction zone. If the data interaction interface is moved out of the interaction zone, a data interaction interface disappearing instruction is generated. According to the data interaction interface disappearing instruction, the data interaction interface is not displayed on the screen, while the interaction zone and the data interaction interface trigger zone are displayed on the screen.

According to an example, a user interface gesture recognizer (UIGestureRecognizer) class may be configured for the data interaction interface. The position information of the data interaction interface on the screen is obtained by using the UIGestureRecognizer class, and it is determined whether the data interaction interface is moved out of the interaction zone. If the data interaction interface is moved out of the interaction zone, the data interaction interface disappearing instruction is generated. According to the data interaction interface disappearing instruction, the data interaction interface is not displayed on the screen, while the interaction zone and the data interaction interface trigger zone are displayed on the screen again.

According to an example, a contact for changing the interaction mode may be configured on the data interaction interface. After the data interaction interface corresponding to the data interaction interface trigger zone is displayed on the screen, an interaction mode changing instruction is received after the contact for changing the interaction mode is clicked by the user. Then, the data interaction interface is not displayed on the screen, and the interaction zone and the at least one data interaction interface trigger zone are displayed again.

In the above descriptions, the operating system of iOS and the UIGestureRecognizer class are taken as examples, which is not used to limit the present disclosure, and other operating systems and classes may be used.

FIG. 6 is a schematic diagram illustrating another interaction interface of a smart device according to various examples of the present disclosure. As shown in FIG. 6, the data interaction interface includes a box of a Tenpay account number, a box of an interaction password and a paying box. In addition the data interaction interface further includes a key of “change”. The key of “change” is a contact for changing an interaction mode. After the data interaction interface corresponding to the data interaction interface trigger zone is displayed on the screen, the user may click the key of “change” to trigger corresponding logic, so that the data interaction interface is not displayed, and the interaction zone and the data interaction interface trigger zone are displayed again.

As can be seen, in the examples of the present disclosure, operation characteristics of the smart device, such as multi-touch, sliding and dragging, are fully utilized. When using the interaction method of the smart device, the user does not need to perform click operations painfully, but only need to drag one of the data interaction interface trigger zones indicating different interaction modes to the interaction zone, and then the data interaction interface including a password input box may be displayed automatically.

According to an example, the user may select one data interaction interface trigger zone indicating a certain payment mode by using a finger, e.g. the Tenpay balance payment data interaction interface trigger zone shown in FIG. 4. Then, the user only needs to drag the Tenpay balance payment data interaction interface trigger zone to the interaction zone which is located in the middle of the screen, so as to finish the selection processing. Afterwards, the data interaction interface corresponding to the Tenpay balance payment data interaction interface trigger zone is displayed on the screen. The data interaction interface includes an interaction password input box and so on. The user may input the password via the data interaction interface to finish the interaction processing.

In the procedure of moving the data interaction interface trigger zone by the user, the smart device may determine whether the data interaction interface trigger zone is moved to the interaction zone according to the position of the finger of the user. After the finger dragging the data interaction interface trigger zone arrives at the interaction zone and leaves the screen, the data interaction interface trigger zone enters the interaction zone automatically. Therefore, it is unnecessary for the user to drag the whole the data interaction interface trigger zone to the interaction zone, only part of the data interaction interface trigger zone needs to be dragged in the interaction zone, thereby simplifying operations of the user and improving interaction efficiency.

Further, when needing to change the interaction mode, the user only needs to click the displayed data interaction interface and slide in any direction by using the finger, then the data interaction interface leaves the interaction zone and the data interaction interface trigger zone corresponding to the data interaction interface returns to the data interaction interface trigger zone list. According to an example, when the finger dragging the data interaction interface is in the interaction zone, if the finger leaves the screen, the data interaction interface trigger zone will return to the interaction zone. If the position of finger is out of the interaction zone when the finger leaves the screen, the data interaction interface trigger zone list will be displayed automatically, and the data interaction interface trigger zone will return to the data interaction interface trigger zone list. In this way, when the finger leaves the screen, if the position of the finger is still in the interaction zone, this operation is regarded as an error operation, and the data interaction interface trigger zone will not return to the data interaction interface trigger zone list. If the position of the finger is outside the interaction zone, this operation is regarded as the operation performed by the user deliberately, and the data interaction interface trigger zone returns to the data interaction interface trigger zone list. Therefore, operation errors made by the user are prevented.

The examples of the present disclosure may be applied to various browsers of various smart devices. The browser may be the Internet Explorer of Microsoft, Firefox of Mozilla, Safari of Apple, Opera, Google Chrome, or Green Browser.

Many browsers of the smart devices are provided above, which are not used to limit the present disclosure. Any application, which may display files in a web page server or in a file system and allow users to interact with files, may be used in practical applications. The application may be various current browsers or any application having a web page browsing function.

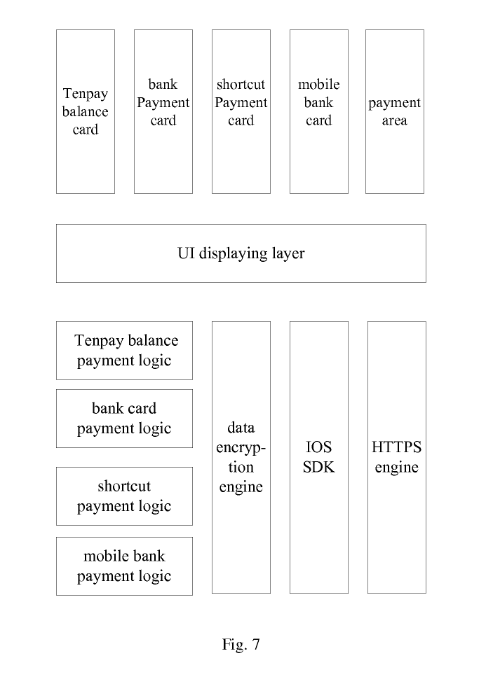

FIG. 7 is a schematic diagram illustrating logic layers for implementing interaction of a smart device according to various examples of the present disclosure.

As shown in FIG. 7, there are three layers of logic. The bottom layer is a service layer and includes service logic of Tenpay balance interaction, bank card interaction, shortcut interaction and mobile bank card interact. By using a HTTPS network engine at the bottom layer, the logic sends service operations of the user to a remote server to implement the service logic. Because the interaction operations of the user are private and sensitive, in the bottom layer, a data encryption engine performs encryption processing for data transmitted between the user and the network server. Therefore, user privacy and sensitive information are protected from being stolen or loss, and security of the smart device is enhanced.

According to an example, the UI displaying layer includes 4 data interaction interface trigger zones and interaction zone and displaying elements thereof. By using functions of responding a touch event provided by, e.g. iOS SDK, such as the UIGestureRecognizer class and the subclass, each data interaction interface trigger zone has the function of responding the clicking operation or dragging operation of the user. After the user clicks a certain data interaction interface trigger zone by using a finger and before the finger leaves the screen, the data interaction interface trigger zone moves along with the finger. The position information of the finger on the screen may be obtained by using the UIGestureRecognizer class. The position information also includes the position information when the finger leaves the screen, so that the operation state of the data interaction interface trigger zone may be determined and correct response may be made according to the position information. According to an example, whether the finger leaves the interaction zone is determined according to whether the position of the finger which is returned by the UIGestureRecognizer class object is within the rectangular area of the interaction zone.

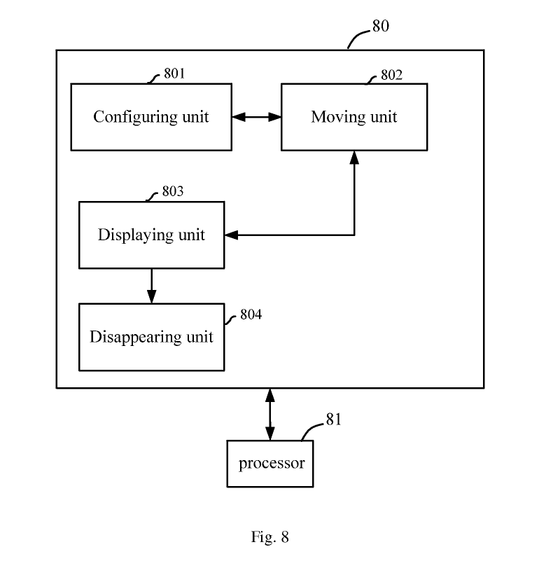

FIG. 8 is a schematic diagram illustrating an interaction apparatus of a smart device according to various examples of the present disclosure.

As shown in FIG. 8, the interaction apparatus includes storage 80 and a processor 81. According to an example, the storage 80 may be non-transitory computer readable storage medium. The storage 80 stores computer readable instructions for implementing a configuring unit 801, a moving unit 802, and a displaying unit 803. The processor 81 may execute the computer readable instructions stored in the storage 80.

The configuring unit 801 is to configure an interaction zone and at least one data interaction interface trigger zone on a screen, each of the at least one the data interaction interface trigger zone corresponds to a data interaction interface.

The moving unit 802 is to receive a touch operation instruction; select and move a data interaction interface trigger zone on the screen according to the touch operation instruction.

The displaying unit 803 is to determine whether the selected data interaction interface trigger zone is moved to the interaction zone. If the selected data interaction interface trigger zone is moved to the interaction zone, the displaying unit 803 is to generate a data interaction interface trigger instruction, display a data interaction interface corresponding to the selected data interaction interface trigger zone on the screen according to the data interaction interface trigger instruction, and perform data interaction on the data interaction interface.

According to an example, the configuring unit 801 is to configure a data interaction interface trigger zone list comprising at least two data interaction interface trigger zones on the screen.

The moving unit 802 is to receive the touch operation instruction; select a data interaction interface trigger zone from the data interaction interface trigger zone list according to the touch operation instruction, and move the selecting data interaction interface trigger zone.

According to an example, the displaying unit 803 is to determine whether the entire selected data interaction interface trigger zone is moved to the interaction zone; if the entire selected data interaction interface trigger zone is moved to the interaction zone, generate the data interaction interface trigger instruction; display the data interaction interface corresponding to the selected data interaction interface trigger zone on the screen according to the data interaction interface trigger instruction; and perform the data interaction on the data interaction interface. According to another example, the displaying unit is to determine whether the partial selected data interaction interface trigger zone is moved to the interaction zone; if the partial selected data interaction interface trigger zone is moved to the interaction zone, generate the data interaction interface trigger instruction; display the data interaction interface corresponding to the selected data interaction interface trigger zone on the screen according to the data interaction interface trigger instruction; and perform the data interaction on the data interaction interface.

According to an example, the screen configuring unit 801 is further to configure a User Interface Gesture Recognizer (UIGestureRecognizer) class for the data interaction interface trigger zone.

When determining whether the selected data interaction interface trigger zone is moved to the interaction zone, the displaying unit 803 is to obtain position information of the selected data interaction interface trigger zone on the screen by using the UIGestureRecognizer class; and determine whether the selected data interaction interface trigger zone is moved to the interaction zone according to the position information.

According to an example, the apparatus further comprises a disappearing unit 804.

The disappearing unit 804 is to determine whether the data interaction interface is moved out of the interaction zone; if the data interaction interface is moved out of the interaction zone, generate a data interaction interface disappearing instruction; not display the data interaction interface on the screen and display the interaction zone and the at least one data interaction interface trigger zone on the screen, according to the data interaction interface disappearing instruction.

According to an example, the configuring unit 801 is further to configure a User Interface Gesture Recognizer (UIGestureRecognizer) class for the data interaction interface.

The disappearing unit 804 is to obtain position information of the data interaction interface on the screen by using the UIGestureRecognizer class; determine whether the data interaction interface is moved out of the interaction zone according to the position information. If the data interaction interface is moved out of the interaction zone, the disappearing unit 804 is to generate the data interaction interface disappearing instruction; not display the data interaction interface on the screen and display the interaction zone and the at least one data interaction interface trigger zone on the screen, according to the data interaction interface disappearing instruction.

According to an example, the configuring unit 801 is to configure a contact for changing an interaction mode on the data interaction interface.

The disappearing unit 804 is to receive an interaction mode changing instruction after the contact for changing the interaction mode is clicked; not display the data interaction interface on the screen and display the interaction zone and the at least one data interaction interface trigger zone on the screen according to the interaction mode changing instruction.

The interaction methods and apparatus of the smart device provided by the examples of the present disclosure may be implemented in many modes. For example, the method may be a plug-in application which may be installed into a computer or a mobile terminal, or may be an application which may be downloaded by users. The modes of the plug-in include ocx, dll, cab and etc. According to an example, the method may be implemented by using technologies, such as a Flash plug-in, a RealPlayer plug-in, a MMS plug-in, a MIDI stave plugin ActiveX plug-in and etc.

A machine-readable storage medium is also provided, which is to store instructions to cause a machine to execute a method as described herein. The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

In addition, the interaction method may be applied to a storage medium based on Nand flash, such as a U disk, a CF card, a SD card, a SDHC card, a MMC card, a SM card, a Memory Stick, a xD card and etc.

The methods and apparatus described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Therefore, according to the examples of the present disclosure, the interaction zone and at least one data interaction interface trigger zone are configured on the screen, and each of the at least one the data interaction interface trigger zone corresponding to one data interaction interface. The touch operation instruction is received, and the data interaction interface trigger zone is selected and moved on the screen according to the touch operation instruction. It is determined whether the selected data interaction interface trigger zone is moved to the interaction zone. If the selected data interaction interface trigger zone is moved to the interaction zone, the data interaction interface corresponding to the selected data interaction interface trigger zone is displayed on the screen and data interaction is performed on the data interaction interface. By using the examples of the present disclosure, many click operations are eliminated, the selecting and interaction determining of the data interaction interface trigger zone is implemented by using the dragging operation, thereby reducing complexity of the user operations and to improving interaction efficiency.

Moreover, the examples of the present disclosure may be used for multi-touch smart device, thereby saving operation time of the user and further improving the interaction efficiency.

What is claimed is:

1. An interaction method of a smart device, comprising:
configuring an interaction zone and at least one data interaction interface trigger zone on a screen, each of the at least one the data interaction interface trigger zone corresponding to a data interaction interface;
receiving a touch operation instruction;
selecting and moving a data interaction interface trigger zone on the screen according to the touch operation instruction;
determining whether the selected data interaction interface trigger zone is moved to the interaction zone;
if the selected data interaction interface trigger zone is moved to the interaction zone, generating a data interaction interface trigger instruction;
displaying a data interaction interface corresponding to the selected data interaction interface trigger zone on the screen according to the data interaction interface trigger instruction; and
performing data interaction on the data interaction interface.

2. The interaction method of claim 1, wherein configuring the at least one data interaction interface trigger zone on the screen comprises: configuring a data interaction interface trigger zone list comprising at least two data interaction interface trigger zones on the screen; and
selecting and moving a data interaction interface trigger zone on the screen according to the touch operation instruction comprises:
selecting a data interaction interface trigger zone from the data interaction interface trigger zone list according to the touch operation instruction, and moving the selecting data interaction interface trigger zone.

3. The interaction method of claim 1, wherein
determining whether the selected data interaction interface trigger zone is moved to the interaction zone; and if the selected data interaction interface trigger zone is moved to the interaction zone, generating a data interaction interface trigger instruction comprises:
determining whether the entire selected data interaction interface trigger zone is moved to the interaction zone; if the entire selected data interaction interface trigger zone is moved to the interaction zone, generating the data interaction interface trigger instruction; or
determining whether the partial selected data interaction interface trigger zone is moved to the interaction zone; if the partial selected data interaction interface trigger zone is moved to the interaction zone, generating the data interaction interface trigger instruction.

4. The interaction method of claim 1, further comprising:
configuring a User Interface Gesture Recognizer (UIGestureRecognizer) class for the data interaction interface trigger zone,
wherein determining whether the selected data interaction interface trigger zone is moved to the interaction zone comprises:
obtaining position information of the selected data interaction interface trigger zone on the screen by using the UIGestureRecognizer class; and
determining whether the selected data interaction interface trigger zone is moved to the interaction zone according to the position information.

5. The interaction method of claim 1, further comprising:
determining whether the data interaction interface is moved out of the interaction zone;
if the data interaction interface is moved out of the interaction zone, generating a data interaction interface disappearing instruction; not displaying the data interaction interface on the screen and displaying the interaction zone and the at least one data interaction interface trigger zone on the screen, according to the data interaction interface disappearing instruction.

6. The interaction method of claim 5, further comprising:
configuring a User Interface Gesture Recognizer (UIGestureRecognizer) class for the data interaction interface,
wherein determining whether the data interaction interface is moved out of the interaction zone; and if the data interaction interface is moved out of the interaction zone, generating the data interaction interface disappearing instruction comprises:
obtaining position information of the data interaction interface on the screen by using the UIGestureRecognizer class; and
determining whether the data interaction interface is moved out of the interaction zone according to the position information; and if the data interaction interface is moved out of the interaction zone, generating the data interaction interface disappearing instruction.

7. The interaction method of claim 1, further comprising:
configuring a contact for changing an interaction mode on the data interaction interface;
receiving an interaction mode changing instruction after the contact for changing the interaction mode is clicked;
not displaying the data interaction interface on the screen and displaying the interaction zone and the at least one data interaction interface trigger zone on the screen according to the interaction mode changing instruction.

8. An interaction apparatus of a smart device, comprising:
a configuring unit, to configure an interaction zone and at least one data interaction interface trigger zone on a screen, each of the at least one the data interaction interface trigger zone corresponding to a data interaction interface;
a moving unit, to receive a touch operation instruction; select and move a data interaction interface trigger zone on the screen according to the touch operation instruction; and
a displaying unit, to determine whether the selected data interaction interface trigger zone is moved to the interaction zone; if the selected data interaction interface trigger zone is moved to the interaction zone, generate a data interaction interface trigger instruction; display a data interaction interface corresponding to the selected data interaction interface trigger zone on the screen according to the data interaction interface trigger instruction; and perform data interaction on the data interaction interface.

9. The interaction apparatus of claim 8, wherein
the configuring unit is to configure a data interaction interface trigger zone list comprising at least two data interaction interface trigger zones on the screen; and
the moving unit is to receive the touch operation instruction; select a data interaction interface trigger zone from the data interaction interface trigger zone list according to the touch operation instruction, and move the selecting data interaction interface trigger zone.

10. The interaction apparatus of claim 8, wherein
the displaying unit is to determine whether the entire selected data interaction interface trigger zone is moved to the interaction zone; if the entire selected data interaction interface trigger zone is moved to the interaction zone, generate the data interaction interface trigger instruction; display the data interaction interface corresponding to the selected data interaction interface trigger zone on the screen according to the data interaction interface trigger instruction; and perform the data interaction on the data interaction interface; or
the displaying unit is to determine whether the partial selected data interaction interface trigger zone is moved to the interaction zone; if the partial selected data interaction interface trigger zone is moved to the interaction zone, generate the data interaction interface trigger instruction; display the data interaction interface corresponding to the selected data interaction interface trigger zone on the screen according to the data interaction interface trigger instruction; and perform the data interaction on the data interaction interface.

11. The interaction apparatus of claim 8, wherein
the configuring unit is further to configure a User Interface Gesture Recognizer (UIGestureRecognizer) class for the data interaction interface trigger zone;
when determining whether the selected data interaction interface trigger zone is moved to the interaction zone, the displaying unit is to obtain position information of the selected data interaction interface trigger zone on the screen by using the UIGestureRecognizer class; and determine whether the selected data interaction interface trigger zone is moved to the interaction zone according to the position information.

12. The interaction apparatus of claim 8, further comprising:
a disappearing unit, to determine whether the data interaction interface is moved out of the interaction zone; if the data interaction interface is moved out of the interaction zone, generate a data interaction interface disappearing instruction; not display the data interaction interface on the screen and display the interaction zone and the at least one data interaction interface trigger zone on the screen, according to the data interaction interface disappearing instruction.

13. The interaction apparatus of claim 12, wherein
the configuring unit is further to configure a User Interface Gesture Recognizer (UIGestureRecognizer) class for the data interaction interface; and
the disappearing unit is to obtain position information of the data interaction interface on the screen by using the UIGestureRecognizer class; determine whether the data interaction interface is moved out of the interaction zone according to the position information; if the data interaction interface is moved out of the interaction zone, generate the data interaction interface disappearing instruction; not display the data interaction interface on the screen and display the interaction zone and the at least one data interaction interface trigger zone on the screen, according to the data interaction interface disappearing instruction.

14. The interaction apparatus of claim 8, further comprising:
a disappearing unit;
wherein the configuring unit is to configure a contact for changing an interaction mode on the data interaction interface; and
wherein the disappearing unit is to receive an interaction mode changing instruction after the contact for changing the interaction mode is clicked; not display the data interaction interface on the screen and display the interaction zone and the at least one data interaction interface trigger zone on the screen according to the interaction mode changing instruction.
